(19) United States
(12) Patent Application Publication
(10) Pub. No.: US 2016/0341569 A1
(43) Pub. Date: Nov. 24, 2016

(54) METHOD OF CALIBRATING GEOMAGNETIC SENSOR AND ELECTRONIC DEVICE ADAPTED THERETO

(71) Applicant: Samsung Electronics Co., Ltd., Suwon-si (KR)

(72) Inventor: Chihun WON, Suwon-si (KR)

(21) Appl. No.: 15/159,215

(22) Filed: May 19, 2016

(30) Foreign Application Priority Data
May 21, 2015 (KR) 10-2015-0071182

(51) Int. Cl. G01C 25/00; G01C 21/08

(52) U.S. Cl. CPC G01C 25/00; G01C 21/08

(57) ABSTRACT

A method of calibrating geomagnetic sensor information (measurements) and an electronic device adapted to the method are provided. The method of calibrating geomagnetic sensor information in an electronic device includes identifying a calibration level of a first calibration sphere, determining whether the calibration level is less than a preset level, and if the calibration level is less than the preset level, receiving a second calibration sphere from at least one external electronic device. Other embodiments are also provided.

### CROSS-REFERENCE TO RELATED APPLICATION(S)

This application claims the benefit under 35 U.S.C. §119(a) of a Korean patent application filed on May 21, 2015 in the Korean Intellectual Property Office and assigned Serial number 10-2015-0071182, the entire disclosure of which is hereby incorporated by reference.

### TECHNICAL FIELD

The present disclosure relates to a method of calibrating geomagnetic sensor information (measurements) and an electronic device adapted to the method.

### BACKGROUND

In recent years, electronic devices such as mobile terminals have been developed to measure geomagnetic sensor information (e.g., azimuth, pitch, and roll), using geomagnetic sensors (i.e., an earth magnetic field sensor). Electronic devices are capable of providing measured geomagnetic sensor information to various types of applications, so that users can use the applications in various ways.

When electronic devices with a geomagnetic sensor are close to magnetic materials (e.g., steel frame structures, power cables, magnets, etc.) during operation, the geomagnetic sensors may output distorted sensor information. In this case, distorted sensor information needs to be calibrated. Geomagnetic sensors may calibrate the distorted sensor information by using a scale factor and an offset. The scale factor and offset may be obtained as electronic devices are manually calibrated by users. For example, a geomagnetic sensor of an electronic device may be calibrated as the user applies a motion to the electronic device, by drawing a figure eight (e.g., Mobius strip). While users are moving with the electronic device with a geomagnetic sensor, the geomagnetic sensor experiences different environments that vary according to the user's locations. Therefore, the user needs to manually calibrate the geomagnetic sensor. This inconveniences the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above mentioned problems and/or disadvantages and to provide at least the advantages described below. Accordingly, an aspect of the of the present disclosure is to provide a method and apparatus for obtaining, when a geomagnetic sensor of an electronic device needs to be calibrated, calibration-related information from other electronic devices located close to the electronic device, and automatically calibrating the geomagnetic sensor based on the obtained information.

In accordance with an aspect of the present disclosure, a method of calibrating geomagnetic sensor information in an electronic device is provided. The method includes identifying a calibration level of a first calibration sphere, determining whether the calibration level is less than a preset level, and when the calibration level is less than the preset level, receiving a second calibration sphere from at least one external electronic device.

In accordance with another aspect of the present disclosure, an electronic device is provided. The electronic device includes a geomagnetic sensor, a communication module, a processor electrically connected to the geomagnetic sensor and the communication module, and a memory electrically connected to the processor. The memory stores instructions for causing, when executed, the processor to identify a calibration level of a first calibration sphere, determine whether the calibration level is less than a preset level, and, when the calibration level is less than the preset level, receive a second calibration sphere from at least one external electronic device via the communication module.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram explaining a network environment including an electronic device according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a block diagram showing a geomagnetic sensor calibrating system of an electronic device according to various embodiments of the present disclosure;

FIG. 5 is a flowchart that describes a method of calibrating distorted geomagnetic sensor information in an electronic device according to various embodiments of the present disclosure;

FIG. 6 shows diagrams that describe a method of manually calibrating a geomagnetic sensor of an electronic device according to various embodiments of the present disclosure;

FIG. 7 shows graphs related to a method of calibrating distorted geomagnetic sensor information based on a first calibration sphere of an electronic device according to various embodiments of the present disclosure;

FIG. 8 shows graphs related to a method of calibrating distorted geomagnetic sensor information based on a second calibration sphere of an electronic device according to various embodiments of the present disclosure; and

FIG. 9 shows a diagram that describes a method for an electronic device to obtain calibration sphere information from an external electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, operation, element, component, or combination thereof described in a specification and does not exclude presence or addition of at least one other characteristic, numeral, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not to limit the present disclosure but to illustrate embodiments of the present disclosure. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA)), a portable multimedia player (PMP), an Moving Picture Experts Group phase 1 or phase 2 (MPEG-1 or MPEG-2) audio layer 3 (MP3) player, a portable medical device, a digital camera, or a wearable device (e.g., an head-mounted device (HMD) such as electronic glasses, electronic clothes, an electronic bracelet, an electronic necklace, an electronic appcessory, or a smart watch).

According to various embodiments of the present disclosure, an electronic device may be a smart home appliance that involves a communication function. For example, an electronic device may be a television (TV), a digital veristle disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to various embodiments of the present disclosure, an electronic device may be a medical device (e.g., magnetic resonance angiography (MRA), magnetic resonance imaging (MRI), computed tomography (CT), ultrasonography, etc.), a navigation device, a global positioning system (GPS) receiver, an event data recorder (EDR), an flight data recorder FDR), a car infotainment device, electronic equipment for ship (e.g., a marine navigation system, a gyrocompass, etc.), avionics, security equipment, or an industrial or home robot.

According to various embodiments of the present disclosure, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof.

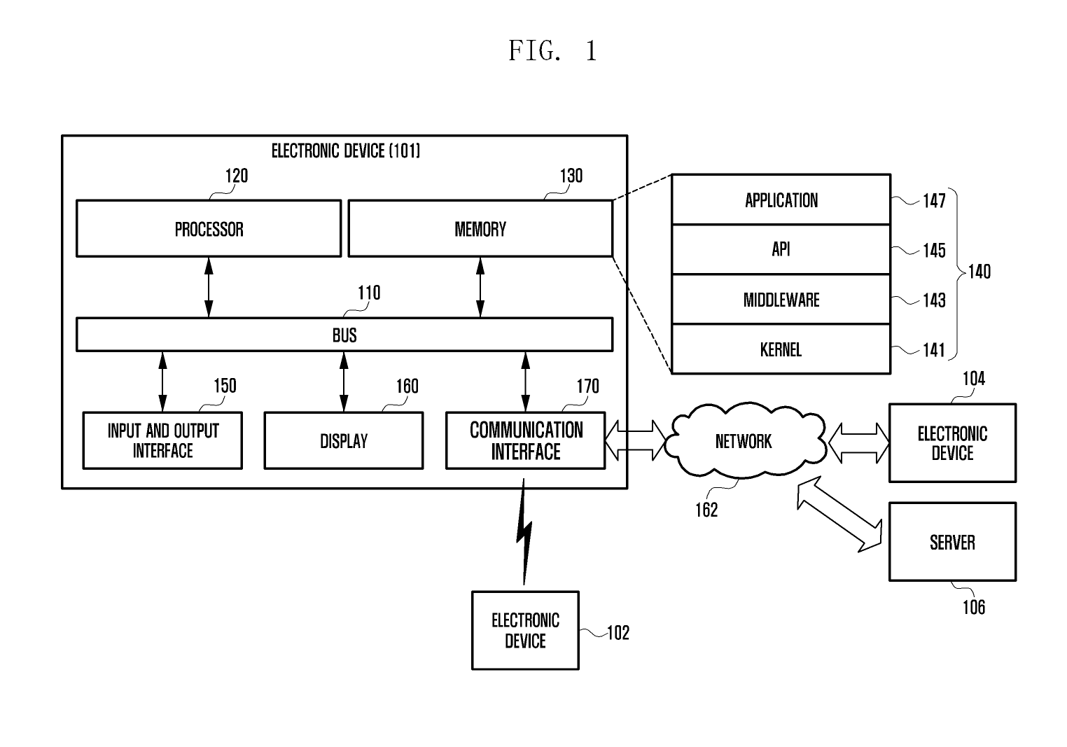

FIG. 1 is a block diagram illustrating an electronic device according to an embodiment of the present disclosure.

Referring to FIG. 1, the electronic device 101 may include a bus 110, a processor 120, a memory 130, a user input module 150, a display 160, and a communication interface 170.

The bus 110 may be a circuit for interconnecting elements described above and for allowing a communication, e.g. by transferring a control message, between the elements described above.

The processor 120 can receive commands from the above-mentioned other elements, e.g. the memory 130, the user input module 150, the display 160, and the communication interface 170, through, for example, the bus 110, can decipher the received commands, and perform operations and/or data processing according to the deciphered commands.

The memory 130 can store commands received from the processor 120 and/or other elements, e.g. the user input module 150, the display 160, and the communication interface 170, and/or commands and/or data generated by the processor 120 and/or other elements. The memory 130 may include softwares and/or programs 140, such as a kernel 141, middleware 143, an application programming interface (API) 145, and an application 147. Each of the programming modules described above may be configured by software, firmware, hardware, and/or combinations of two or more thereof.

The kernel 141 can control and/or manage system resources, e.g. the bus 110, the processor 120 or the memory 130, used for execution of operations and/or functions implemented in other programming modules, such as the middleware 143, the API 145, and/or the application 147. Further, the kernel 141 can provide an interface through which the middleware 143, the API 145, and/or the application 147 can access and then control and/or manage an individual element of the electronic device 101.

The middleware 143 can perform a relay function which allows the API 145 and/or the application 147 to communicate with and exchange data with the kernel 141. Further, in relation to operation requests received from at least one of an application 147, the middleware 143 can perform load balancing in relation to the operation requests by, for example, giving a priority in using a system resource, e.g. the bus 110, the processor 120, and/or the memory 130, of the electronic device 101 to at least one application from among the at least one of the application 147.

The API 145 is an interface through which the application 147 can control a function provided by the kernel 141 and/or the middleware 143, and may include, for example, at least one interface or function for file control, window control, image processing, and/or character control.

The user input module 150 can receive, for example, a command and/or data from a user, and transfer the received command and/or data to the processor 120 and/or the memory 130 through the bus 110. The display 160 can display an image, a video, and/or data to a user.

The communication interface 170 can establish a communication between the electronic device 101 and another electronic devices 102 and 104 and/or a server 106. The communication interface 170 can support short range communication protocols, e.g. a Wi-Fi protocol, a Bluetooth (BT) protocol, and a near field communication (NFC) protocol, communication networks, e.g. Internet, local area network (LAN), wide area network (WAN), a telecommunication network, a cellular network, and a satellite network, or a plain old telephone service (POTS), or any other similar and/or suitable communication networks, such as network 162, or the like. Each of the electronic devices 102 and 104 may be a same type and/or different types of electronic device.

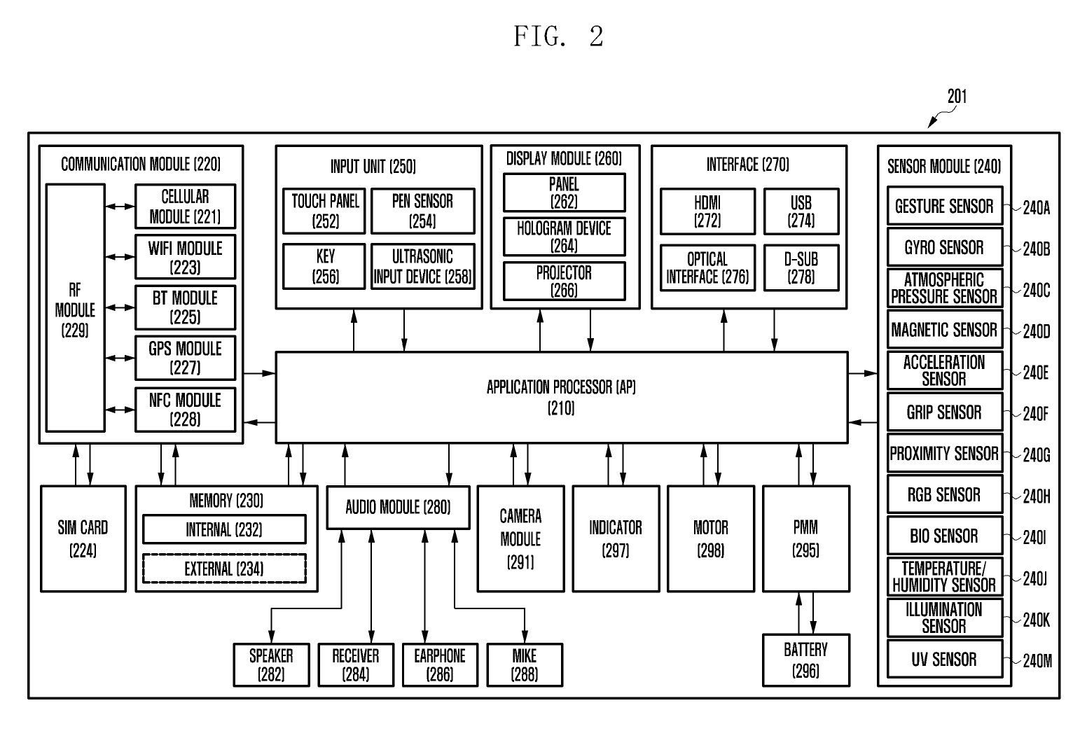

FIG. 2 is a block diagram illustrating an electronic device in accordance with an embodiment of the present disclosure. The electronic device 201 may form, for example, the whole or part of the electronic device 101 shown in FIG. 1.

Referring to FIG. 2, the electronic device 201 may include at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

The communication module 220 (e.g., the communication interface 160) may perform a data communication with any other electronic device (e.g., the electronic device 104 or the server 106) connected to the electronic device 200 (e.g., the electronic device 101) through the network. According to an embodiment, the communication module 220 may include therein a cellular module 221, a WiFi module 223, a BT module 225, a GPS module 227, an NFC module 228, and an Radio Frequency (RF) module 229.

The cellular module 221 may offer a voice call, a video call, a message service, an internet service, or the like through a communication network (e.g., long term evolution (LTE), LTE-advanced (LTE-A), code division multiple access (CDMA), wideband code division multiple access (WCDMA), universal mobile telecommunications system (UMTS), wireless broadband (WiBro), or Global System for Mobile Communications (GSM), etc.). Additionally, the cellular module 221 may perform identification and authentication of the electronic device in the communication network, using the SIM card 224. According to an embodiment of the present disclosure, the cellular module 221 may perform at least part of functions the AP 210 can provide. For example, the cellular module 221 may perform at least part of a multimedia control function.

According to an embodiment of the present disclosure, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

According to an embodiment of the present disclosure, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single integrated circuit (IC) chip or a single IC package in an embodiment of the present disclosure. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a power amp module (PAM), a frequency filter, an Low Noise Amplifier (LNA), or the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 224 may be a specific card formed of SIM and may be inserted into a slot (not shown) formed at a certain place of the electronic device. The SIM card 224 may contain therein an integrated circuit card IDentifier (ICCID) or an international mobile subscriber identity (IMSI).

The memory 230 (e.g., the memory 130) may include an internal memory 232 and an external memory 234. The internal memory 232 may include, for example, at least one of a volatile memory (e.g., dynamic random access memory (DRAM), static RAM (SRAM), synchronous DRAM (SDRAM), etc.) or a nonvolatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment of the present disclosure, the internal memory 232 may have the form of an solid state drive (SSD). The external memory 234 may include a flash drive, e.g., compact flash (CF), secure digital (SD), micro-SD, mini-SD, eXtreme Digital (xD), memory stick, or the like. The external memory 234 may be functionally connected to the electronic device 200 through various interfaces. According to an embodiment, the electronic device 200 may further include a storage device or medium such as a hard drive.

The sensor module 240 may measure physical quantity or sense an operating status of the electronic device 200, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature-humidity sensor 240J, an illumination sensor 240K, and a ultraviolet (UV) sensor 240M. Additionally or alternatively, the sensor module 240 may include, e.g., an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 240 may include a control circuit for controlling one or more sensors equipped therein.

The input unit 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 200 through an input tool that generates ultrasonic signals, thus allowing wireless recognition. According to an embodiment, the electronic device 200 may receive a user input from any external device (e.g., a computer or a server) connected thereto through the communication module 220.

The display 260 (e.g., the display 150) may include a panel 262, a hologram 264, or a projector 266. The panel 262 may be, for example, liquid crystal display (LCD), active matrix organic light emitting diode (AM-OLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 200. According to an embodiment, the display 260 may further include a control circuit for controlling the panel 262, the hologram 264, and the projector 266.

The interface 270 may include, for example, an high-definition multimedia interface (HDMI) 272, a universal serial bus (USB) 274, an optical interface 276, or a D-subminiature (D-sub) 278. The interface 270 may be contained, for example, in the communication interface 160 shown in FIG. 1. Additionally or alternatively, the interface 270 may include, for example, an mobile high-definition link (MHL) interface, an SD card/multi-media card (MMC) interface, or an infrared data association (IrDA) interface.

The audio module 280 may perform a conversion between sounds and electric signals. At least part of the audio module 280 may be contained, for example, in the input/output interface 140 shown in FIG. 1. The audio module 280 may process sound information inputted or outputted through a speaker 282, a receiver 284, an earphone 286, or a microphone 288.

The camera module 291 is a device capable of obtaining still images and moving images. According to an embodiment of the present disclosure, the camera module 291 may include at least one image sensor (e.g., a front sensor or a rear sensor), a lens (not shown), an image signal processor (ISP) not shown, or a flash (e.g., LED or xenon lamp, not shown).

The power management module 295 may manage electric power of the electronic device 200. Although not shown, the power management module 295 may include, for example, a power management integrated circuit (PMIC), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 200. The battery 296 may be, for example, a rechargeable battery or a solar battery.

The indicator 297 may show thereon a current status (e.g., a booting status, a message status, or a recharging status) of the electronic device 200 or of its part (e.g., the AP 210). The motor 298 may convert an electric signal into a mechanical vibration. Although not shown, the electronic device 200 may include a specific processor (e.g., GPU) for supporting a mobile TV. This processor may process media data that comply with standards of digital multimedia broadcasting (DMB), digital video broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of application-specific integrated circuit (ASIC) chip, field-programmable gate arrays (FPGAs), and programmable-logic device, which have been known or are to be developed.

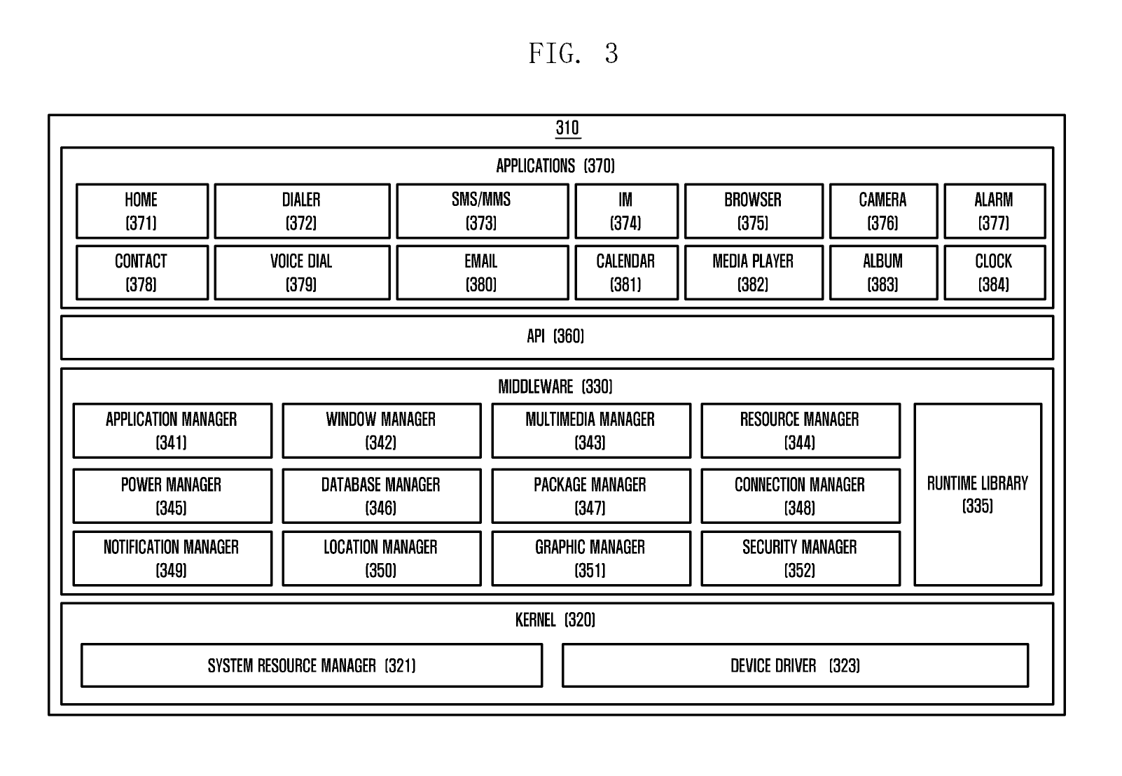

FIG. 3 is a block diagram illustrating a configuration of a programming module according to an embodiment of the present disclosure.

The programming module may be included (or stored) in the electronic device 101 (e.g., the memory 130) or may be included (or stored) in the electronic device 200 (e.g., the memory 230) illustrated in FIG. 1. At least a part of the programming module may be implemented in software, firmware, hardware, or a combination of two or more thereof. The programming module 300 may be implemented in hardware (e.g., the hardware 200), and may include an OS controlling resources related to an electronic device (e.g., the electronic device 101) and/or various applications (e.g., an application) executed in the OS. For example, the OS may be Android, iOS, Windows, Symbian, Tizen, Bada, and the like.

Referring to FIG. 3, the programming module 300 may include a kernel 320, a middleware 330, an API 360, and/or an application 370.

The kernel 320 (e.g., the kernel 141) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370.

According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like.

According to an embodiment of the present disclosure, when the electronic device (e.g., the electronic device 101) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third party application. The applications 370 (e.g., the applications 147) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 230. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

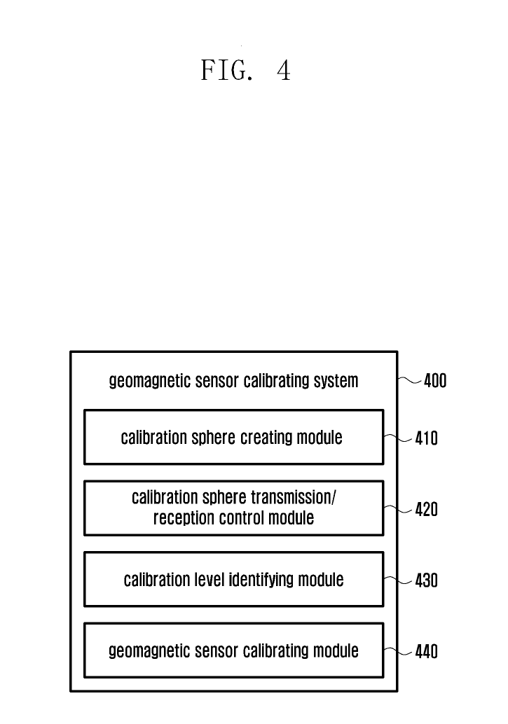

FIG. 4 is a block diagram showing a geomagnetic sensor calibrating system of an electronic device according to various embodiments of the present disclosure.

Referring to FIG. 4, the geomagnetic sensor calibrating system 400 is capable of including a calibration sphere creating module 410, a calibration sphere transmission/reception control module 420, a calibration level identifying module 430, and a geomagnetic sensor calibrating module 440. The geomagnetic sensor calibrating system 400 refers to a system that is capable of calibrating distorted sensor information from the sensor information received from the geomagnetic sensor (earth magnetic field sensor), and providing precise sensor information to users.

According to various embodiments of the present disclosure, the calibration sphere creating module 410 is capable of creating a calibration sphere, as a standard, for calibrating distorted geomagnetic sensor information. The calibration sphere creating module 410 needs a user's manual motion (e.g., moving the electronic device by drawing a figure eight, rotating the electronic device 360°, etc.). The calibration sphere creating module 410 is capable of collecting data related to X-, Y- and Y-axis magnetic fields of the geomagnetic sensor, by the user's manual motion. In particular, the calibration sphere creating module 410 defines the upper limit (+) and the lower limit (−) in the respective axes, and determines the quantity of data, thereby creating a calibration sphere in 3-dimension.

According to various embodiments of the present disclosure, the calibration sphere creating module 410 is capable of obtaining a scale factor and an offset to calibrate the distorted sensor information from the created calibration sphere. The obtained scale factor and offset may be standards for calibrating the distorted sensor information. Detailed processes for calibration may be performed in the geomagnetic sensor calibrating module 440.

According to various embodiments of the present disclosure, the calibration sphere creating module 410 is capable of obtaining a scale factor (X_{sf}, Y_{sf}) and an offset (X_{off}, Y_{off}) by using the following Equation 1. The maximum (Xₘₐₓ, Yₘₐₓ) and the minimum (Xₘᵢₙ, Yₘᵢₙ) in the respective axes may be obtained from the created calibration sphere. The scale factor, offset, maximum and minimum for the Z-axis can be calculated in the same way as the X- and Y-axes.

X_{sf}=max(1,(Yₘₐₓ−Yₘᵢₙ)/(Xₘₐₓ−Xₘᵢₙ))

Y_{sf}=max(1,(Xₘₐₓ−Xₘᵢₙ)/(Yₘₐₓ−Yₘᵢₙ))

X_{off}=[(Xₘₐₓ−Xₘᵢₙ)/2−Xₘₐₓ]×X_{sf}

Y_{off}=[(Yₘₐₓ−Yₘᵢₙ)/2−Yₘₐₓ]×Y_{sf} Equation 1

According to various embodiments of the present disclosure, the calibration sphere transmission/reception control module 420 is capable of controlling the communication module 220 to transmit a calibration sphere as a standard for calibrating geomagnetic sensor information to external electronic devices 102 and 104. Therefore, the electronic devices 101 and 201 are capable of receiving a calibration sphere from the external electronic devices via the calibration sphere transmission/reception control module 420, without a user's manual motion for creating a calibration sphere (e.g., a motion of moving the electronic device by drawing a figure eight, a motion of rotating the electronic device 360°, etc.). The external electronic device may experience at least one manual motion to create a calibration sphere. The external electronic device is capable of collecting data related to X-, Y- and Y-axis magnetic fields of the geomagnetic sensor, by the manual motion. In particular, the external electronic device defines the upper limit (+) and the lower limit (−) in the respective axes, and determines the quantity of data, thereby creating a calibration sphere in 3-dimension.

According to various embodiments of the present disclosure, the calibration sphere transmission/reception control module 420 is capable of controlling the communication module 220 to transmit a calibration sphere created by the calibration sphere creating module 410 or a calibration sphere received by the calibration sphere transmission/reception control module 420 to the external electronic devices 102 and 104. That is, the calibration sphere transmission/reception control module 420 is capable of receiving a request for transmission of a calibration sphere from the external electronic devices 102 and 104, and transmitting, to the external electronic devices 102 and 104, a calibration sphere stored in the electronic devices 101 and 201 according to the request. Therefore, the external electronic devices 102 and 104 are capable of receiving a calibration sphere from the electronic devices 101 and 201, without a user's manual motion for creating a calibration sphere (e.g., a motion of moving the electronic device by drawing a figure eight, a motion of rotating the electronic device 360°, etc.).

According to various embodiments of the present disclosure, when the calibration sphere transmission/reception control module 420 receives a request for transmitting a calibration sphere from the external electronic devices 102 and 104, it is capable of requesting the calibration level identifying module 430 to identify a calibration level of a calibration sphere stored in the electronic devices 101 and 201. When the calibration level of the calibration sphere stored in the electronic device is greater than or equal to a preset level, the calibration sphere transmission/reception control module 420 is capable of controlling the transmission of a calibration sphere to the external electronic devices 102 and 104. On the other hand, when the calibration level of the calibration sphere stored in the electronic device is less than a preset level, the calibration sphere transmission/reception control module 420 is capable of notifying the external electronic devices 102 and 104 that the current calibration sphere cannot be transmitted.

According to various embodiments of the present disclosure, when a calibration level of the electronic devices 101 and 201, identified by the calibration level identifying module 430, is less than a preset level, the calibration sphere transmission/reception control module 420 is capable of controlling the reception of calibration spheres with a level greater than or equal to a preset level from the external electronic devices 102 and 104. The calibration level refers to the precision of a calibration sphere. The electronic device is capable of calibrating distorted geomagnetic sensor information based on a calibration sphere. The higher the calibration level of a calibration sphere the more precisely the electronic device calibrates the distorted geomagnetic sensor information. The calibration level may be set to the maximum level (e.g., level 3) right after a manual calibration has been performed. As the user moves or time goes by, the electronic devices 101 and 201 may experience environments where the strength of the geomagnetic fields varies and this may reduce the calibration level of the geomagnetic sensor to a level (e.g., levels 0 to 2). For example, when the calibration level of the geomagnetic sensor is less than level 3, the electronic device cannot precisely calibrate the distorted sensor information. Therefore, the electronic device needs to receive a calibration sphere of which the calibration level is level 3 from an external electronic device, and calibrates the distorted sensor information. When the calibration level of the calibration spheres of the external electronic devices 102 and 104 is not the maximum level (e.g., level 3), the calibration sphere transmission/reception control module 420 is capable of performing the controlling process so that the calibration sphere is not received from the beginning To this end, a process for previously identifying a calibration level of an external electronic device may be performed.

According to various embodiments of the present disclosure, the calibration sphere transmission/reception control module 420 is capable of controlling the reception of the maximum (Xₘₐₓ, Yₘₐₓ, Zₘₐₓ) and minimum (Xₘᵢₙ, Yₘᵢₙ, Zₘᵢₙ) in respective axes for the calibration sphere from an external electronic device, and also a scale factor (X_{sf}, Y_{sf}, Z_{sf}) and an offset (X_{off}, Y_{off}, Z_{off}). The scale factor and offset, obtained from the external electronic device, may be standards for calibrating distorted sensor information. Detailed processes for calibration may be performed in the geomagnetic sensor calibrating module 440. The calibration level may be identified by the calibration level identifying module 430.

According to various embodiments of the present disclosure, the calibration sphere transmission/reception control module 420 is capable of receiving a calibration sphere from external electronic devices, based on distance as a first priority condition. For example, the calibration sphere transmission/reception control module 420 is capable of controlling the reception of a calibration sphere from an external electronic device as the electronic device and the external electronic device are close to each other. That is, in order to obtain precise geomagnetic sensor information, the calibration sphere transmission/reception control module 420 is capable of obtaining a calibration sphere from external electronic devices 102 and 104 close to the electronic devices 101 and 201. This is because the smaller the absolute distance between the electronic device and the external electronic device the larger the probability that the nearby magnetic field environment of the external electronic device is similar to that of the electronic device.

According to various embodiments of the present disclosure, the calibration sphere transmission/reception control module 420 is capable of making a comparison of the distances between the electronic device and an external electronic device, based on received signal strength indication (RSSI) of the external electronic device connected to a short-range network (e.g., Bluetooth, Wi-Fi Direct, etc.). For example, the smaller the distance between an electronic device and an external electronic device, the larger the RSSI from the external electronic device. Therefore, the calibration sphere transmission/reception control module 420 is capable of controlling the reception of a calibration sphere or information regarding the calibration sphere (e.g., the maximum, the minimum, a scale factor, an offset, a calibration level, the time elapsed since calibration, etc., in respective axes) from an external electronic device which has a larger strength of RSSI, from among the two or more external electronic devices.

According to various embodiments of the present disclosure, the calibration sphere transmission/reception control module 420 is capable of making a comparison of the distances between the electronic device and the external electronic device, based on the location based service (LBS) and the triangulation. According to the triangulation, when the RSSIs of signals from three base stations (Stations) or access points (APs) are represented with corresponding circles, one region superimposed by the areas of the three circles may be a place where the external electronic devices 102 and 104 are located. Therefore, the electronic device 101 or 201 is capable of receiving information regarding an external electronic device closest to the current electronic device, using the LBS. The calibration sphere transmission/reception control module 420 is capable of controlling the reception of a calibration sphere or information regarding the calibration sphere (e.g., the maximum, the minimum, a scale factor, an offset, a calibration level, the time elapsed since calibration, etc., in respective axes) from an external electronic device closest to the electronic device.

According to various embodiments of the present disclosure, the calibration sphere transmission/reception control module 420 is capable of controlling the reception of a calibration sphere via an AP. The AP is capable of receiving information related to a calibration sphere (e.g., the maximum, the minimum, a scale factor, an offset, a calibration level, the time elapsed since calibration, etc., in respective axes) from at least one of the external electronic devices 102 and 104. The AP is capable of arranging the received information related to a calibration sphere in order of priority. The AP is capable of transmitting the information related to calibration with the higher priority to the electronic devices 101 and 201, periodically or according to a calibration sphere request from the electronic device. When the AP determines the order of priority and arranges information related to a calibration sphere, it may exclude information regarding a calibration sphere of which the calibration level is less than a preset level. Therefore, the calibration sphere transmission/reception control module 420 is capable of controlling the reception of a calibration sphere with the highest order of priority from the AP. Alternatively, the calibration sphere transmission/reception control module 420 may control the reception of information related to a calibration sphere of one or more external electronic devices from the AP, regardless of the order of priority, and directly arrange and use the received information based on the order of priority.

According to various embodiments of the present disclosure, the calibration sphere transmission/reception control module 420 is capable of receiving calibration spheres from external electronic devices, based on the time elapsed since calibration as a second priority condition. For example, when the electronic device is spaced apart from a first external electronic device and a second external electronic device, by the same distance or distances deemed to be the same (e.g., the difference between the distances from the external electronic device to the first external electronic device and the second external electronic device is within a preset range), respectively, the calibration sphere transmission/reception control module 420 may set the order of priority in order of time elapsed since calibration from shortest to longest, and receive calibration spheres from external electronic devices. When the difference between the distances from the electronic device to the external electronic devices is not distinct, the time elapsed since calibration as a second priority condition is effective because the lesser the amount of time elapsed since calibration, the higher the probability that the condition includes a precise geomagnetic field environment where the external electronic device is currently located.

According to various embodiments of the present disclosure, when the calibration sphere transmission/reception control module 420 detects a user's manual calibration while receiving a calibration sphere from an external electronic device, it is capable of stopping the reception of the calibration sphere. The precision of the calibration sphere created in the electronic device is greater than that of the external electronic device. When the control module 420 detects a user's manual calibration, it may replace the calibration sphere with a newly created calibration sphere.

According to various embodiments of the present disclosure, the calibration level identifying module 430 is capable of identifying a calibration level of a calibration sphere used for calibration. The calibration level refers to the precision of a calibration sphere. The electronic device is capable of calibrating distorted geomagnetic sensor information based on a calibration sphere. The higher the calibration level of a calibration sphere the more precisely the electronic device calibrates the distorted geomagnetic sensor information. The calibration sphere may be a calibration sphere produced in the electronic device or received from a system outside the electronic device. The calibration level of a calibration sphere may be set to the maximum level (e.g., level 3) right after a manual calibration has been performed. As the user moves or time goes by, the electronic devices 101 and 201 may experience environments where the strength of the geomagnetic fields varies and this may reduce the calibration level of the calibration sphere (e.g., levels 0 to 2). For example, when the calibration level of the calibration sphere is less than level 3, the electronic device cannot precisely calibrate the distorted sensor information. Therefore, the electronic device may be controlled by manual calibration or receive a calibration sphere of which the calibration level is level 3 from the outside, thereby calibrating the distorted sensor information.

According to various embodiments of the present disclosure, when the calibration level identifying module 430 ascertains that the calibration level of a calibration sphere is less than a preset level, it is capable of requesting manual calibration from the user. The request for manual calibration from a user may be performed by at least one of a sound, a vibration, a scent, a text message, etc.

According to various embodiments of the present disclosure, when the calibration level identifying module 430 ascertains that the calibration level of a calibration sphere is less than a preset level, it is capable of controlling the calibration sphere transmission/reception control module 420 to automatically receive a calibration sphere of an external electronic device or information related to the calibration sphere. Therefore, the electronic device can calibrate distorted sensor information produced by the geomagnetic sensor.

According to various embodiments of the present disclosure, the geomagnetic sensor calibrating module 440 is capable of calibrating distorted sensor information produced by the geomagnetic sensor. The geomagnetic sensor calibrating module 440 is capable of calibrating distorted sensor information by selecting a calibration sphere as a calibration standard.

According to various embodiments of the present disclosure, the geomagnetic sensor calibrating module 440 is capable of calibrating distorted sensor information based on a calibration sphere of electronic devices 101 and 201. The geomagnetic sensor calibrating module 440 is capable of obtaining a scale factor and an offset for calibrating distorted sensor information from a calibration sphere of an electronic device. The obtained scale factor and offset may serve as standards for calibrating distorted sensor information. The calibration sphere of an electronic device may be created in the calibration sphere creating module 410.

According to various embodiments of the present disclosure, when the calibration level of the calibration sphere, produced in the electronic devices 101 and 201 and identified by calibration level identifying module 430, is less than a preset level, the geomagnetic sensor calibrating module 440 is capable of calibrating distorted sensor information based on the calibration sphere of external electronic devices 102 and 104. The geomagnetic sensor calibrating module 440 is capable of obtaining a scale factor and an offset for calibrating distorted sensor information from a calibration sphere of an external electronic device. Alternatively, the geomagnetic sensor calibrating module 440 may directly obtain a scale factor and an offset from an external electronic device and use them to calibrate distorted sensor information. The obtained scale factor and offset may serve as standards for calibrating distorted sensor information. The calibration sphere of an external electronic device or the information related to the calibration sphere may be received by the calibration sphere transmission/reception control module 420.

According to various embodiments of the present disclosure, the geomagnetic sensor calibrating module 440 is capable of calibrating distorted sensor information (X_{reading}, Y_{reading}) through the following Equation 2, thereby obtaining precise sensor information (Xᵥₐₗᵤₑ, Yᵥₐₗᵤₑ). Distorted sensor information and precise sensor information for the Z-axis may also be calculated in the same way as the X- and Y-axes.

Xᵥₐₗᵤₑ=X_{sf}×X_{reading}+X_{off}

Yᵥₐₗᵤₑ=Y_{sf}×Y_{reading}+Y_{off} Equation 2

In various embodiments of the present disclosure, the electronic device includes a geomagnetic sensor, a communication module, a processor electrically connected to the geomagnetic sensor and the communication module, and a memory electrically connected to the processor. The memory stores instructions for causing, when executed, the processor to identify a calibration level of a first calibration sphere, determine whether the calibration level is less than a preset level, and, when the calibration level is less than a preset level, receive a second calibration sphere from at least one external electronic device via the communication module.

In various embodiments of the present disclosure, the instructions cause the processor to calibrate the geomagnetic sensor information based on the second calibration sphere.

In various embodiments of the present disclosure, when the calibration level is less than a preset level, the instructions cause the processor to inform a user that the calibration sphere needs to be updated.

In various embodiments of the present disclosure, the instructions cause the processor to inform a user that the calibration sphere needs to be updated, by using at least one of a sound, a vibration, a scent, and a text message.

In various embodiments of the present disclosure, the instructions cause the processor to detect a user's manual calibration, create a third calibration sphere, based on the manual calibration, and calibrate the geomagnetic sensor information based on the third calibration sphere.

In various embodiments of the present disclosure, the instructions cause the processor to control the communication module to connect the electronic device to the at least one external electronic device, via at least one short-range wireless communication mode.

In various embodiments of the present disclosure, the instructions cause the processor to detect the manual calibration while the second calibration sphere is received, and stop the reception of the second calibration sphere.

In various embodiments of the present disclosure, when the second calibration sphere is received from the at least one external electronic device, the instructions cause the processor to make a comparison between the distances from the electronic device to the external electronic devices, and receive the second calibration sphere from an external electronic device closest to the electronic device.

In various embodiments of the present disclosure, when the distances from the electronic device to the external electronic devices are identical to each other or the difference between the distances is within a preset value, the instructions cause the processor to make a comparison between the periods of time that the second calibration spheres are created, and receive the second calibration spheres based on the comparison result.

In various embodiments of the present disclosure, the instructions cause the processor to make a comparison between RSSIs from the external electronic devices, make a comparison between APs through which the external electronic devices perform communication, and make a comparison between locations of the external electronic devices based on a location based service (LBS) in order to make a comparison between the distances.

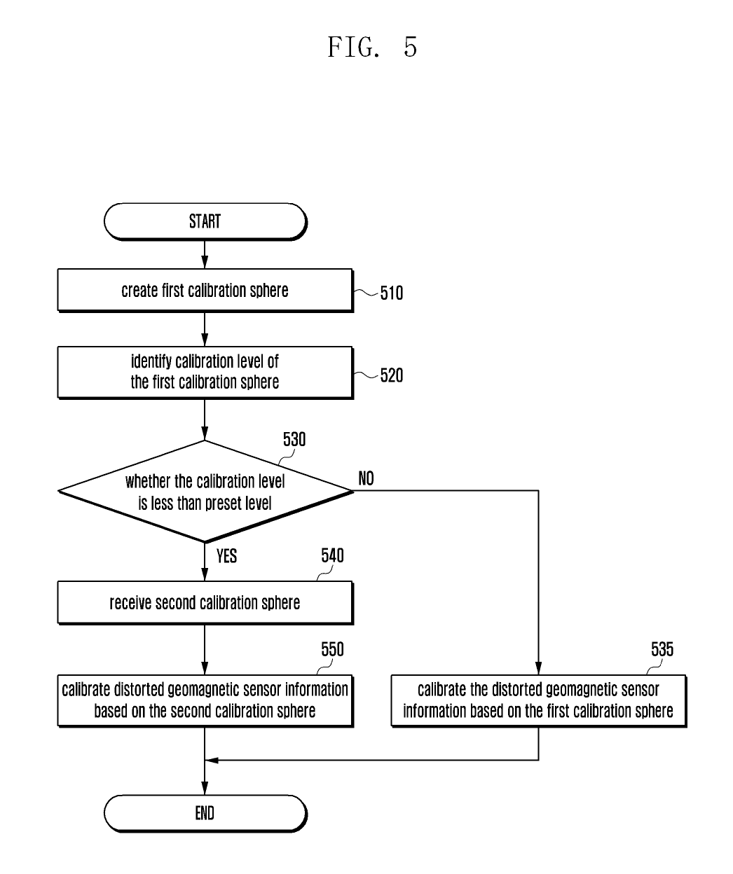

FIG. 5 is a flowchart that describes a method of calibrating distorted geomagnetic sensor information in an electronic device according to various embodiments of the present disclosure.

Referring to FIG. 5, the electronic device 101 or 201 is capable of creating a first calibration sphere in operation 510.

The electronic device is capable of creating a first calibration sphere, as a standard, for calibrating distorted geomagnetic sensor information in operation 510. To create a first calibration sphere, the electronic device needs a user's manual motion (e.g., a motion of moving the electronic device by drawing a figure eight, a motion of rotating the electronic device 360°, etc.). The electronic device is capable of collecting data related to X-, Y- and Y-axis magnetic fields of the geomagnetic sensor, by detecting the user's manual calibration. In particular, the electronic device defines the upper limit (+) and the lower limit (−) in the respective axes, and determines the quantity of data, thereby creating a first calibration sphere in 3-dimension.

The electronic device is capable of identifying a calibration level of the first calibration sphere in operation 520. The calibration level of the first calibration sphere may be set to the maximum level (e.g., level 3) right after manual calibration has been performed. As the user moves or time goes by, the electronic device may experience environments where the strength of the geomagnetic fields varies and this may reduce the calibration level of the first calibration sphere to a level (e.g., levels 0 to 2). For example, when the calibration level of the first calibration sphere is less than level 3, the electronic device cannot precisely calibrate the distorted sensor information. Therefore, the electronic device needs to create a new calibration sphere by receiving a new user's manual calibration or to receive a calibration sphere of which the calibration level is level 3 from the outside, and then calibrates the distorted sensor information via the calibration sphere.

The electronic device is capable of determining whether the calibration level of the first calibration sphere is less than a preset level in operation 530.

When the electronic device ascertains that the calibration level of the first calibration sphere is greater than or equal to a preset level in operation 530, it is capable of calibrating the distorted geomagnetic sensor information based on the first calibration sphere in operation 535.

The electronic device is capable of obtaining a scale factor and an offset for calibrating distorted sensor information from the first calibration sphere in operation 535. The obtained scale factor and offset may be standards for calibrating distorted sensor information.

The electronic device is capable of obtaining a scale factor (X_{sf}, Y_{sf}) and an offset (X_{off}, Y_{off}) by using Equation 1 in operation 535. The maximum (Xₘₐₓ, Yₘₐₓ) and the minimum (Xₘᵢₙ, Yₘᵢₙ) in the respective axes may be obtained from the created first calibration sphere. The scale factor, offset, maximum and minimum for the Z-axis can be calculated in the same way as the X- and Y-axes.

The electronic device is capable of calibrating distorted sensor information (X_{reading}, Y_{reading}) through Equation 2, thereby obtaining precise sensor information (Xᵥₐₗᵤₑ, Yᵥₐₗᵤₑ), in operation 535. Distorted sensor information and precise sensor information for the Z-axis may also be calculated in the same way as the X- and Y-axes.

On the other hand, when the electronic device ascertains that the calibration level of the first calibration sphere is less than a preset level in operation 530, it is capable of receiving a second calibration sphere as a standard for calibrating geomagnetic sensor information from the external electronic devices 102 and 104 in operation 540. That is, the electronic devices 101 and 201 are capable of receiving a second calibration sphere from external electronic devices, without a user's manual motion for creating a new calibration sphere (e.g., a motion of moving the electronic device by drawing a figure eight, a motion of rotating the electronic device 360°, etc.). The external electronic device may perform at least one manual calibration to create a second calibration sphere. The external electronic device is capable of collecting data related to X-, Y- and Y-axis magnetic fields of the geomagnetic sensor, by the manual motion. In particular, the external electronic device defines the upper limit (+) and the lower limit (−) in the respective axes, and determines the quantity of data, thereby creating a second calibration sphere in 3-dimension.

The electronic device is capable of receiving information regarding the second calibration sphere (e.g., the maximum, the minimum, a scale factor, an offset, a calibration level, the time elapsed since calibration, etc., in respective axes) from an external electronic device in operation 540. Therefore, the electronic device is capable of calibrating distorted sensor information, using the received scale factor and the received offset, without an additional operation procedure for obtaining a scale factor and an offset.

The electronic device is capable of receiving a second calibration sphere from an external electronic device, based on distance as a first priority condition in operation 540. For example, the electronic device is capable of receiving a second calibration sphere from an external electronic device according as the electronic device and the external electronic device are close to each other. This is because the smaller the absolute distance between the electronic device and the external electronic device the larger the probability that the nearby magnetic field environment of the external electronic device is similar to that of the electronic device.

The electronic device is capable of making a comparison of the distances between the electronic device and external electronic devices, based on RSSI values of the external electronic devices connected to a short-range network (e.g., Bluetooth, Wi-Fi Direct, etc.) in operation 540. For example, the smaller the distance between an electronic device and an external electronic device, the larger the RSSI from the external electronic device. Therefore, the electronic device is capable of receiving a second calibration sphere or information regarding the second calibration sphere (e.g., the maximum, the minimum, a scale factor, an offset, a calibration level, the time elapsed since calibration, etc., in respective axes) from an external electronic device which has a high level of RSSI, from among the two or more external electronic devices.

According to various embodiments of the present disclosure, the electronic device is capable of making a comparison of the distances between the electronic device and the external electronic device, based on the LBS and the triangulation in operation 540. According to the triangulation, when the RSSIs of signals from three base stations (Stations) or APs are represented with corresponding circles, one region superimposed by the areas of the three circles may be a place where the external electronic devices 102 and 104 are located. Therefore, the electronic device 101 or 201 is capable of receiving information regarding an external electronic device closest to the current electronic device, using the LBS. The electronic device is capable of receiving a second calibration sphere or information regarding the second calibration sphere (e.g., the maximum, the minimum, a scale factor, an offset, a calibration level, the time elapsed since calibration, etc., in respective axes) from an external electronic device closest to the electronic device.

According to various embodiments of the present disclosure, the electronic device is capable of receiving a second calibration sphere via an AP in operation 540. The AP is capable of receiving information related to a second calibration sphere (e.g., the maximum, the minimum, a scale factor, an offset, a calibration level, the time elapsed since calibration, etc., in respective axes) from at least one of the external electronic devices 102 and 104. The AP is capable of arranging the received information related to a second calibration sphere in order of priority. The AP is capable of transmitting the information related to a second calibration with the higher priority to the electronic devices 101 and 201, periodically or according to a calibration sphere request from the electronic device. When the AP determines the order of priority and arranges information related to a second calibration sphere, it may exclude information regarding a second calibration sphere of which the calibration level is less than a preset level. Therefore, the electronic device is capable of receiving a calibration sphere with the highest order of priority from the AP. Alternatively, the electronic device may receive information related to a second calibration sphere of one or more external electronic devices from the AP, regardless of the order of priority, and directly arrange and use the received information based on the order of priority.

According to various embodiments of the present disclosure, the electronic device is capable of receiving second calibration spheres from external electronic devices, based on the time elapsed since calibration as a second priority condition, in operation 540. For example, when the electronic device is spaced apart from a first external electronic device and a second external electronic device, with the same distance or distances deemed to be the same (e.g., the difference between the distances from the external electronic device to the first external electronic device and the second external electronic device is within a preset range), respectively, the electronic device may set the order of priority in order of time elapsed since calibration from shortest to longest, and receive second calibration spheres from external electronic devices. When the difference between the distances from the electronic device to the external electronic devices is not distinct, the time elapsed since calibration as a second priority condition is effective because the shorter the time elapsed since calibration, the higher the probability that the condition includes a precise geomagnetic field environment where the external electronic device is currently located.

According to various embodiments of the present disclosure, when the electronic device detects a user's manual calibration while receiving a second calibration sphere from an external electronic device, it is capable of stopping the reception of the calibration sphere in operation 540. The precision of the calibration sphere created in the electronic device is greater than that of the external electronic device. When the electronic device detects a user's manual calibration, it may replace the calibration sphere with a newly created calibration sphere.

In an embodiment, the electronic device is capable of calibrating distorted geomagnetic sensor information based on the second calibration sphere in operation 550.

The electronic device is capable of obtaining a scale factor and an offset for calibrating distorted sensor information from the second calibration sphere in operation 550. The obtained scale factor and offset may serve as standards for calibrating distorted sensor information.

The electronic device is capable of obtaining a scale factor (X_{sf}, Y_{sf}) and an offset (X_{off}, Y_{off}) by using Equation 1 in operation 550. The maximum (Xₘₐₓ, Yₘₐₓ) and the minimum (Xₘᵢₙ, Yₘᵢₙ) in the respective axes may be obtained from the received second calibration sphere. The scale factor, offset, maximum and minimum for the Z-axis can be calculated in the same way as the X- and Y-axes.

The electronic device is capable of calibrating distorted sensor information (X_{reading}, Y_{reading}) through Equation 2, thereby obtaining precise sensor information (Xᵥₐₗᵤₑ, Yᵥₐₗᵤₑ), in operation 550. Distorted sensor information and precise sensor information for the Z-axis may also be calculated in the same way as the X- and Y-axes.

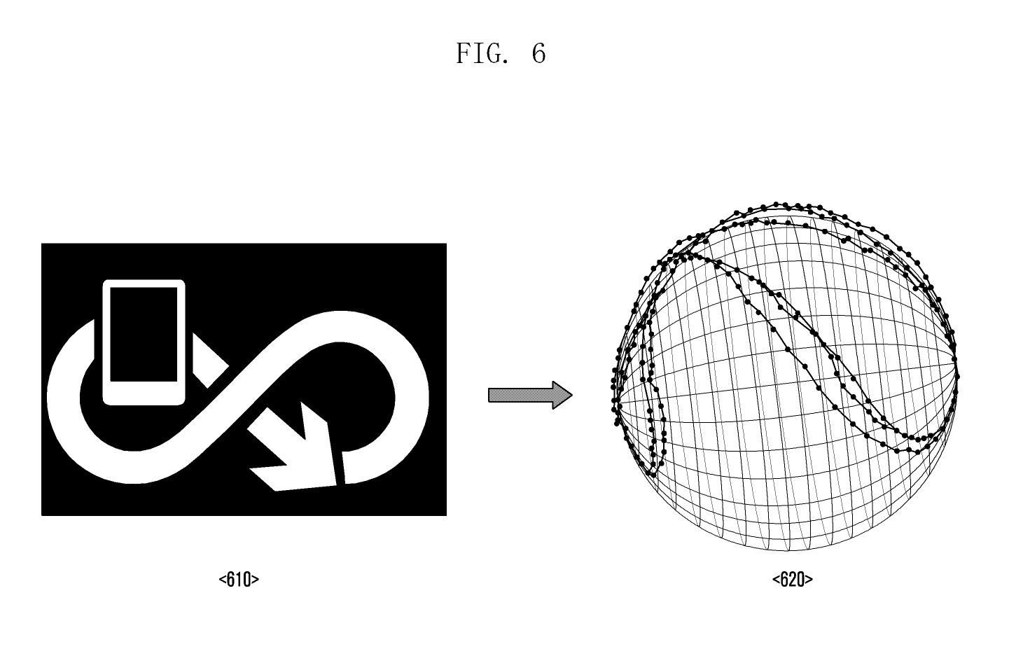

FIG. 6 shows diagrams that describe a method of manually calibrating a geomagnetic sensor of an electronic device according to various embodiments of the present disclosure.

Referring to FIG. 6, the electronic device 101 or 201 is capable of detecting the presence of a manual calibration as shown in diagram 610. Examples of the manual calibration are a motion of moving an electronic device by drawing a figure eight, a motion of rotating an electronic device 360°, etc. When the electronic device detects a manual calibration, it is capable of collecting data related to X-, Y- and Z-axis magnetic fields of the geomagnetic sensor. In particular, the electronic device defines the upper limit (+) and the lower limit (−) in the respective axes, and determines the quantity of data, thereby creating a calibration sphere in 3-dimension as shown in diagram 620 of FIG. 6. The electronic device is capable of obtaining a scale factor and an offset by using the created calibration sphere show in diagram 620, and calibrating the distorted sensor information by using the obtained scale factor and offset.

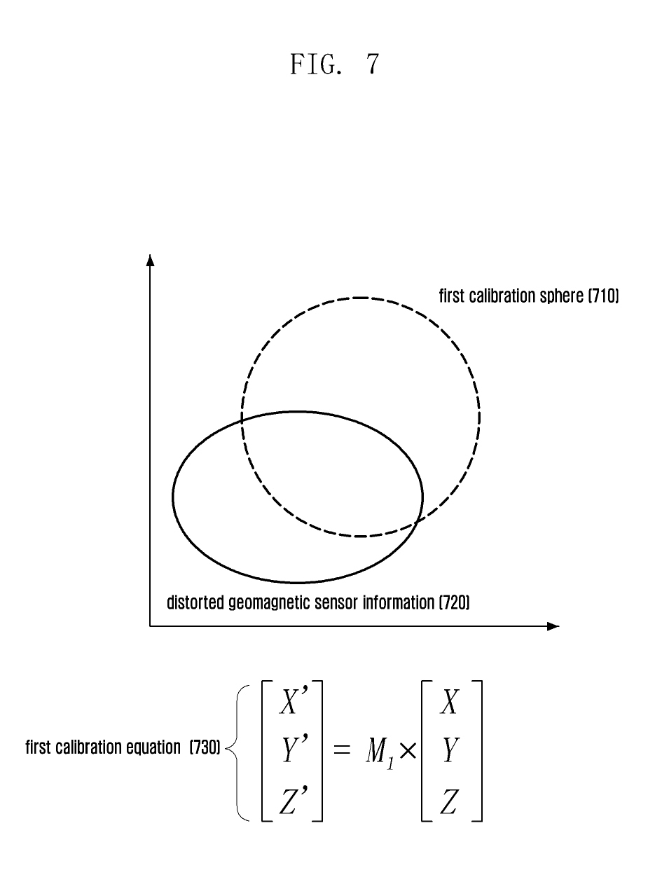

FIG. 7 shows graphs related to a method of calibrating distorted geomagnetic sensor information based on a first calibration sphere of an electronic device according to various embodiments of the present disclosure.

Referring to FIG. 7, a first calibration sphere and distorted geomagnetic sensor information, created by a manual calibration in an electronic device 101 or 201, are represented by graphs 710 and 720 respectively. The electronic device is capable of calibrating distorted geomagnetic sensor information represented by graph 720, out of a range of first calibration sphere represented by graph 710, based on the first calibration sphere. The electronic device is capable of calibrating distorted geomagnetic sensor information 720 using matrix M₁ in first calibration equation 730. Matrix M₁ may include scale factors and offsets of the first calibration sphere.

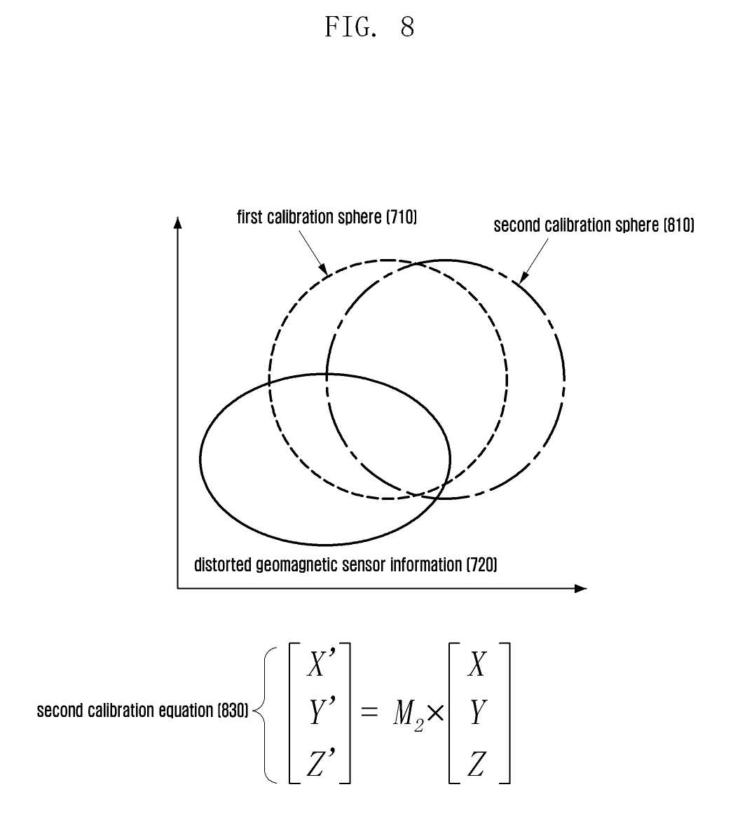

FIG. 8 shows graphs related to a method of calibrating distorted geomagnetic sensor information based on a second calibration sphere of an electronic device according to various embodiments of the present disclosure.

Referring to FIG. 8, a first calibration sphere and distorted geomagnetic sensor information, created by a manual calibration in an electronic device 101 or 201, are represented by graphs 710 and 720 respectively. In addition, a second calibration sphere received from an external electronic device 102 and 104 is represented by graph 810. When the calibration level of the first calibration sphere represented by graph 710 is less than a preset level, the electronic device is capable of calibrating distorted geomagnetic sensor information represented by graph 720, using a calibration sphere of a calibration level higher than that of the first calibration sphere. When the calibration level of the second calibration sphere represented by graph 810 is greater than or equal to a preset level, the electronic device is capable of calibrating distorted geomagnetic sensor information represented by graph 720, based on the second calibration sphere represented by graph 810. Although the embodiment is described assuming that the second calibration sphere 810 is a calibration sphere automatically received from an external electronic device, it should be understood that the present disclosure is not limited thereto. For example, the second calibration sphere 810 may be a calibration sphere newly created by a user's manual calibration. The electronic device is capable of calibrating distorted geomagnetic sensor information 720 using matrix M₂ in second calibration equation 830. Matrix M₂ may include scale factors and offsets of the second calibration sphere.

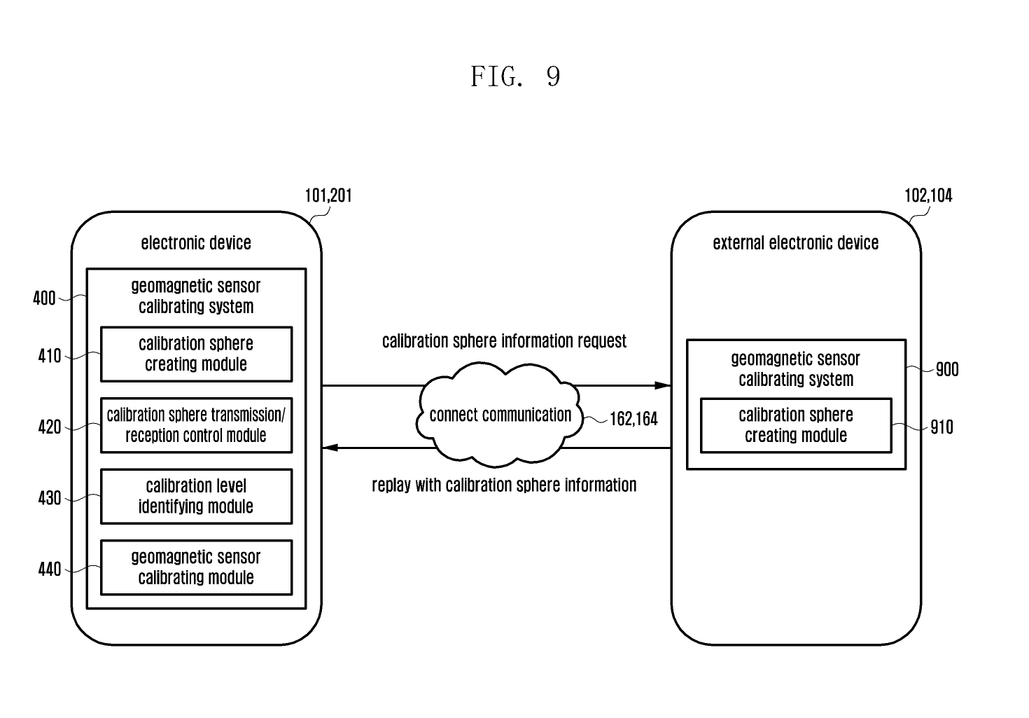

FIG. 9 shows a diagram that describes a method for an electronic device to obtain calibration sphere information from an external electronic device according to various embodiments of the present disclosure.

Referring to FIG. 9, the electronic device 101 or 201 is capable of including a geomagnetic sensor calibrating system 400. The electronic device 101 or 201 is capable of requesting a calibration sphere of an external electronic device from an external electronic device 102 or 104, via the calibration sphere transmission/reception control module 420.

The external electronic device 102 or 104 is capable of including a unique geomagnetic sensor calibrating system 900. The external electronic device 102 or 104 is capable of creating a calibration sphere of an external electronic device, by using a unique calibration sphere creating module 910. It should be understood that the geomagnetic sensor calibrating system 900 may further include a calibration sphere transmission/reception control module, a calibration level identifying module or a geomagnetic sensor calibrating module, etc., as well as the calibration sphere creating module 910.

According to various embodiments of the present disclosure, when receiving a calibration sphere information request from the electronic device 101 or 201, the external electronic device 102 or 104 is capable of transmitting the calibration sphere to the electronic device 101 or 201. That is, the electronic device 101 or 201 receives a unique calibration sphere from an external electronic device 102 or 104 and calibrates the distorted geomagnetic sensor information based on the received calibration sphere.

In various embodiments of the present disclosure, the method of calibrating geomagnetic sensor information in an electronic device includes identifying a calibration level of a first calibration sphere, determining whether the calibration level is less than a preset level, and when the calibration level is less than a preset level, receiving a second calibration sphere from at least one external electronic device.

In various embodiments of the present disclosure, the method may include calibrating the geomagnetic sensor information based on the second calibration sphere.

In various embodiments of the present disclosure, when the calibration level is less than a preset level, the method may include informing a user that the calibration sphere needs to be updated.

In various embodiments of the present disclosure, informing a user that the calibration sphere needs to be updated is performed by using at least one of a sound, a vibration, a scent, and a text message.

In various embodiments of the present disclosure, the method may further include detecting a user's manual calibration, creating a third calibration sphere based on the manual calibration, and calibrating the geomagnetic sensor information based on the third calibration sphere.

In various embodiments of the present disclosure, the method may include connecting the electronic device to the at least one external electronic device, via at least one short-range wireless communication mode.

In various embodiments of the present disclosure, the method may include detecting the manual calibration while the second calibration sphere is received, and stopping the reception of the second calibration sphere.

In various embodiments of the present disclosure, the reception of a second calibration sphere from at least one external electronic device may include making a comparison between the distances from the electronic device to the external electronic devices, and receiving the second calibration sphere from an external electronic device closest to the electronic device.

In various embodiments of the present disclosure, when the distances from the electronic device to the external electronic devices are identical to each other or the difference between the distances is within a preset value, the reception of a second calibration sphere from at least one external electronic device may include making a comparison between the periods of time that the second calibration spheres are created, and receiving the second calibration sphere based on the comparison result.

In various embodiments of the present disclosure, the process of making a comparison between the distances comprises at least one of making a comparison between RSSIs from the external electronic devices, making a comparison between APs through which the external electronic devices perform communication, and making a comparison between locations of the external electronic devices based on a LBS.

According to various embodiments of the present disclosure, the method of calibrating geomagnetic sensor information automatically calibrates a geomagnetic sensor of an electronic device, using information related to calibration of other electronic devices close to the electronic device, thereby removing any inconvenience arising from the user needing to calibrate the geomagnetic sensor manually and precisely, and always using precise geomagnetic sensor information.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an ASIC chip, a FPGA, and a programmable-logic device for performing certain operations which have been known or are to be developed in the future.

Examples of computer-readable media include magnetic media, such as hard disks, floppy disks, and magnetic tape, optical media such as compact disc ROM (CD-ROM) disks and DVD, magneto-optical media, such as floptical disks, and hardware devices that are specially configured to store and perform program instructions (e.g., programming modules), such as ROM, RAM, flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to the embodiments of the present disclosure may include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations.

While the present disclosure has been shown and described with reference to various embodiments thereof, it will be understood by those skilled in the art that various changes in form and details may be made therein without departing from the spirit and scope of the present disclosure as defined in the appended claims and their equivalents.

What is claimed is:

1. A method of calibrating geomagnetic sensor information in an electronic device, the method comprising:
identifying a calibration level of a first calibration sphere;
determining whether the calibration level is less than a preset level; and
if the calibration level is less than the preset level, receiving a second calibration sphere from at least one external electronic device.

2. The method of claim 1, further comprising:
calibrating the geomagnetic sensor information based on the second calibration sphere.

3. The method of claim 1, further comprising:
when the calibration level is less than the preset level, informing a user that the calibration sphere needs to be updated.

4. The method of claim 3, wherein the informing of the user that the calibration sphere needs to be updated comprises using at least one of a sound, a vibration, a scent, and a text message.

5. The method of claim 3, further comprising:
detecting a user's manual calibration;
creating a third calibration sphere based on the manual calibration; and
calibrating the geomagnetic sensor information based on the third calibration sphere.

6. The method of claim 1, further comprising:
connecting the electronic device to at least one external electronic device via at least one short-range wireless communication mode.

7. The method of claim 5, further comprising:
detecting the manual calibration while the second calibration sphere is received; and
stopping the reception of the second calibration sphere.

8. The method of claim 1, wherein the receiving of the second calibration sphere from at least one external electronic device comprises:
comparing distances from each of the at least one electronic device to the external electronic device; and
receiving the second calibration sphere from an external electronic device closest to the electronic device.

9. The method of claim 8, wherein, when the distances from each of the at least one electronic device to the external electronic device are identical to each other or the difference between the distances is within a preset value, the receiving of the second calibration sphere from the at least one external electronic device comprises:
making a comparison between the periods of time that the second calibration spheres are created; and
receiving the second calibration sphere based on the comparison result.

10. The method of claim 8, wherein the making of the comparison between the distances comprises at least one of:
making a comparison between received signal strength indications (RSSIs) from the external electronic devices;
making a comparison between access points (APs) through which the external electronic devices perform communication; and
making a comparison between locations of the external electronic devices based on a location based service (LBS).

11. An electronic device comprising:
a geomagnetic sensor;
a communication module;
a processor electrically connected to the geomagnetic sensor and the communication module; and
a memory electrically connected to the processor,
wherein the memory stores instructions for causing, when executed, the processor to:
identify a calibration level of a first calibration sphere;
determine whether the calibration level is less than a preset level; and
if the calibration level is less than the preset level, receive a second calibration sphere from at least one external electronic device via the communication module.

12. The electronic device of claim 11, wherein the instructions further cause the processor to calibrate the geomagnetic sensor information based on the second calibration sphere.

13. The electronic device of claim 11, wherein, when the calibration level is less than the preset level, the instructions further cause the processor to inform a user that the calibration sphere needs to be updated.

14. The electronic device of claim 13, wherein the instructions further cause the processor to inform a user that the calibration sphere needs to be updated by using at least one of a sound, a vibration, a scent, and a text message.

15. The electronic device of claim 13, wherein the instructions further cause the processor to:
detect a user's manual calibration;
create a third calibration sphere based on the manual calibration; and
calibrate the geomagnetic sensor information based on the third calibration sphere.

16. The electronic device of claim 11, wherein the instructions further cause the processor to control the communication module to connect the electronic device to at least one external electronic device via at least one short-range wireless communication mode.

17. The electronic device of claim 15, wherein the instructions further cause the processor to:
detect the manual calibration while the second calibration sphere is received; and
stop the reception of the second calibration sphere.

18. The electronic device of claim 11, wherein, when the second calibration sphere is received from the at least one external electronic device, the instructions further cause the processor to:
compare distances from each of the at least one electronic device to the external electronic device; and
receive the second calibration sphere from an external electronic device closest to the electronic device.

19. The electronic device of claim 18, wherein, when the distances from each of the at least one electronic device to the external electronic devices are identical to each other or the difference between the distances is within a preset value, the instructions further cause the processor to:
make a comparison between the periods of time that the second calibration spheres are created; and
receive the second calibration spheres based on the comparison result.

20. The electronic device of claim 18, wherein the instructions further cause the processor to:
make a comparison between received signal strength indications (RSSIs) from the external electronic devices;
make a comparison between access points (APs) through which the external electronic devices perform communication; and
make a comparison between locations of the external electronic devices based on a location based service (LBS) in order to make a comparison between the distances.
